(19) United States
(12) Patent Application Publication
(10) Pub. No.: US 2014/0058810 A1
(43) Pub. Date: Feb. 27, 2014

(54) PREMIUM ADVERTISING COST-SHARING MATCHING METHOD, SYSTEM, AND ADVERTISING GIFT

(71) Applicant: YA-CHANG HWANG, Donggang Township (TW)

(72) Inventor: YA-CHANG HWANG, Donggang Township (TW)

(21) Appl. No.: 13/799,798

(22) Filed: Mar. 13, 2013

(30) Foreign Application Priority Data
Aug. 24, 2012 (TW) 101130883

(51) Int. Cl. G06Q 30/02

(52) U.S. Cl. CPC G06Q 30/0274
USPC 705/14.7

(57) ABSTRACT

The present invention relates to a premium advertising cost-sharing matching method, system, and advertising gift, which provides an advertising gift supplier and the advertisers to choose to share an advertising gift with other advertisers for advertising their own advertisement on said advertising gift and sharing an advertising cost.

### BACKGROUND OF THE INVENTION

1. Field of the Invention

The present invention relates to a premium advertising cost-sharing matching method, system, and advertising gift for a plurality of advertisers to present their own advertisement and share the cost in a common advertising gift.

2. Description of the Related Art

The conventional premium advertisement is that a single advertiser selects his/her own gifts, puts his/her advertisement on the gifts, and gives out the gifts to the consumer. In other words, the advertiser absorbs the advertising cost by himself/herself.

Nevertheless, the total cost of making the advertisement on the gifts includes all cost for all procedures. The advertisement planning which involves which kind of the manufacturing ways and which location to be set on the gifts, the manufacturing mould or/and jigs, and gifts packaging and distributing, all need. money.

Among the above procedures, the advertisement planning and the mould or/and the jigs are varied from different cases and are hardly shared, both of which become disposible and waste resources.

With regard to the premium advertising effect, the better advertising effect works if the gift itself can be accepted and frequently used by consumers, which leading to a high exposure frequency of the advertisement.

However, the conventional premium advertisement is an mono-exclusive advertisement, which magnifies the advertising function of the gift itself strongly. Generally, people do not prefer to show out the gifts from the unknown brands of the small and medium enterprises in public except for the famous brands which represent not only the brand value but also the social identity. Most people may take the gifts for home using or just disuse the gifts, which is a failure in the premium advertisement.

As a matter of fact, for those unknown small and medium enterprises, doing the premium advertisements just like to giving out the leaflets, which only makes a few uses.

It is a pity that those advertising gifts become the flea market goods or the recycling after being stored for years.

The cognition and the identification of the brand occupy a great influence when the consumer receives a gift. However, the brand cultivation takes time. It is hard to create any identification to the consumer when a brand is newly established, which however makes the brand repulsed by the consumer easily.

Since the financial meltdown (crisis) in 2008, the economy is depressed all over the world. Every enterprise is deliberating about how to reduce the cost. The enterprises compete with each other in a lower selling price to attain meager profits. In this meager profit time, such a contradiction directly affects the advertising budget. The cutting down or omission of the advertisements indirectly affects the operation and sale of the enterprises, which causes a vicious circle.

Briefly, the premium advertisement with only single brand wastes the gifts, increases the cost of the advertiser, and wastes the resources.

Furthermore, the premium advertisements are most adopted in local community. In the past, an integrated group advertisement is generated by asking each advertiser for the identification to other advertisiers participated in the group advertisement. The efficiency of such group advertisement is far lower than that of the single advertisement. The cost of the integration is far higher than that of the single advertisement. It is also why the group advertisements are not deemed to involve in a lowering cost and an increased efficiency.

As the express delivery, the internet, and the smart phone are all well-developed, society or community is re-defined for integrating and applying the resources effectively.

### SUMMARY OF THE INVENTION

The present invention is applied to allow the premium advertisement suppliers to render the customers willing to use the gifts for advertising able to share the advertising gift cost precisely. The present invention provides a premium advertising cost-sharing matching, system, and advertising gift, whereby the premium advertisement suppliers allow their advertisers to select whether to share an advertising gift with other advertisers for advertising on the advertising gift together and sharing the advertising cost of the advertising gift.

The present invention pertains to a premium advertising cost-sharing matching method, system, and advertising gift. The method thereof is described as follows:

a premium advertising cost-sharing matching method is applied to operate a human-machine interface in a computer, in a communication interface, or via a remote computer. The human-machine interface provides a gift information in order to seek at least more than one common advertiser, then registers a premium advertising number that the common advertiser needs, and appoints a deadline. The human-machine interface counts an afforded advertising cost according to the premium advertising number requisite for each common advertiser within or after the deadline.

Preferably, the premium advertising cost-sharing matching method count the advertising cost after a number of the common advertisers reaches a predetermined value.

Preferably, the premium advertising cost-sharing matching method plans an advertising content of the gift before counting the advertising cost, then counts a unit cost of each gift according to the accumulative number of the common advertisers, and counts the advertising cost of the common advertiser according to the premium advertising number of each common advertiser.

The method of the present invention can be disclosed in steps, which will be described after the system of the present invention is described.

The premium advertising cost-sharing matching system is operated in a computer, in a communication interface, or via a remote computer and provides a human-machine interface, a customer database, a deadline controller, and a cost counter. The human-machine interface receives an input information of an advertiser and registers the information in the customer database. The input information includes a deadline and a premium advertising number for outputting an expiring signal to the cost counter via the deadline controller when the deadline is expired, and then the cost counter counts a requisite advertising cost afforded by the advertiser.

Preferably, the premium advertising cost-sharing matching system further comprises a sharing counter which is applied to accumulate an accumulative number of the advertisers who are going to share advertisements for a same gift and at a same time. The sharing counter outputs a full signal to the cost counter when the accumulative number is over than or equal to a predetermined value so that the cost counter counts an afforded advertising cost of the advertisers.

Preferably, the cost counter plans an advertising content in accordance with an accumulative number of the advertisers who are going to share advertisements, counts a unit cost of each gift, and then counts the advertising cost of each common advertiser in accordance with the premium advertising number of each advertiser.

Preferably, the premium advertising cost-sharing matching system further comprises a gift database. The gift database includes at least one representative figure of the gifts. The representative figure includes a plurality of advertising areas separated by the gifts.

Preferably, the customer database includes at least one selected gift column, one advertising number column and one deadline column.

The advertising gifts generated by the above-mentioned method and system include a plurality of sharing advertisements. Namely, the present invention provides the advertising gifts which are made by any of the mentioned premium advertising cost-sharing matching method. The advertising gifts include at least more than two advertisements.

The premium advertising cost-sharing matching method may be integrated into step-procedure as follows: The present invention is still applied to operating a human-machine interface in a computer, in a communication interface, or via a remote computer for seeking more than one advertiser willing to share advertisements of a gift, and comprises the steps of:

Step A: applying a customer database on the human-machine interface to seek a sharing advertisement; if yes, following step if no, following step E;

Step B: applying a gift database and the customer database on the human-machine interface to select a gift, input a requisite premium advertising number, and appoint a deadline;

Step C: applying a sharing counter on the human-machine interface to accumulate an accumulative number of the common advertisers for a same gift and at a same time; if the accumulative number has reached a predetermined value, following step E, otherwise following step D;

Step D: applying a deadline controller on the human-machine interface to control whether the deadline input in the step B is expired or not; if yes, following step E; if no, following step C; and Step B: applying a cost counter on the human-machine interface to count an advertising cost afforded by each advertiser in accordance with the premium advertising number.

By applying the aforementioned method and system, the present invention allows an advertising gift to be shared and posted by most of the advertisers, which earns a same or even better advertising efficiency with the shared cost and greatly reduces the cost of single advertisements. Because of the sharing advertisements, the specialized impression could be weakened but still attain the effect of being visually read so as to reduce the waste problem that the consumer do not use gifts after taking them.

### BRIEF DESCRIPTION OF THE DRAWINGS

FIG. 1 is a schematic view showing a system structure of the preferred embodiment of the present invention;

FIG. 2 is a schematic view showing a human-machine interface of the method of the preferred embodiment of the present invention in practice;

FIG. 3 is a flow view showing the method of the preferred embodiment of the present invention;

FIG. 4 is a schematic view showing a first advertising gift of the preferred embodiment of the present invention;

FIG. 5 is a schematic view showing a second advertising gift of the preferred embodiment of the present invention; and

FIG. 6 is a schematic view showing a third advertising gift of the preferred embodiment of the present invention.

### DETAILED DESCRIPTION OF THE PREFERRED EMBODIMENTS

The present invention is described in one preferred embodiment in conjunction with the following figures for an easy understanding. First, the concept of the present invention is described as follows:

A premium advertising cost-sharing matching method, system, and advertising gift of the present invention applies a system which allows a plurality of advertisers to select whether to present their own advertisements individually on a sharing advertising gift and further to share the cost or receive the feedback.

The schematic views showing system, the human-machine interface, the procedure, and the advertising gifts are illustrated in the figures for being conjunction with the description.

System

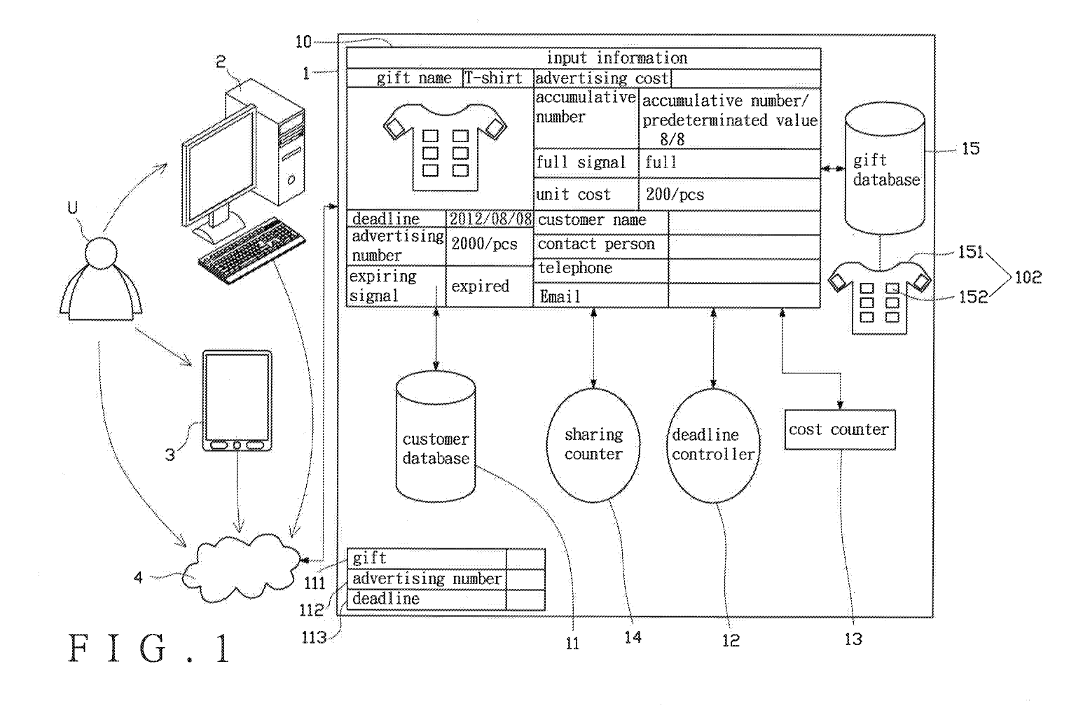

Referring to FIG. 1, a schematic view of the main structure of the premium advertising cost-sharing matching system 1 is shown.

The premium advertising cost-sharing matching system 1 which is operated in a computer 2, in a communication interface 3, or via a remote computer 4, provides a human-machine interface 10, a customer database 11, a deadline controller 12, a cost counter 13, a sharing counter 14, and a gift database 15. The gift database 15 includes at least one representative figure 151 of the gifts 102. The representative figure 151 includes a plurality of advertising areas 152 separated by the gifts 102. The customer database 11 includes at least the following columns: a selected gift column 111, an advertising number column 112, and an deadline column 113.

Human--Machine Interface

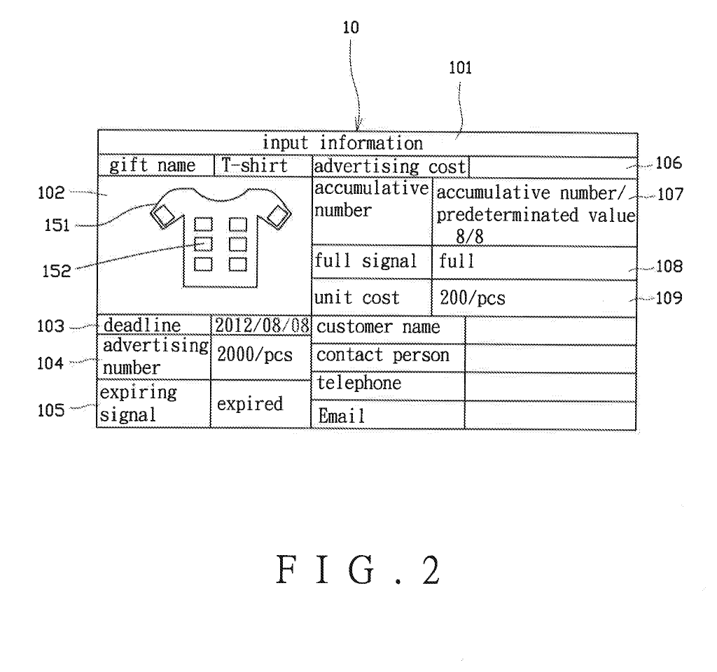

Referring to FIG. 2, the human-machine interface includes:

The human-machine interface 10 receives an input information 101. The input information 101 includes a representative figure 151 of a gift 102, a deadline 103, an advertising number 104, an expiring signal 105, an advertising cost 106, an accumulative number 107, a full signal 108, and a unit cost 109.

Procedure

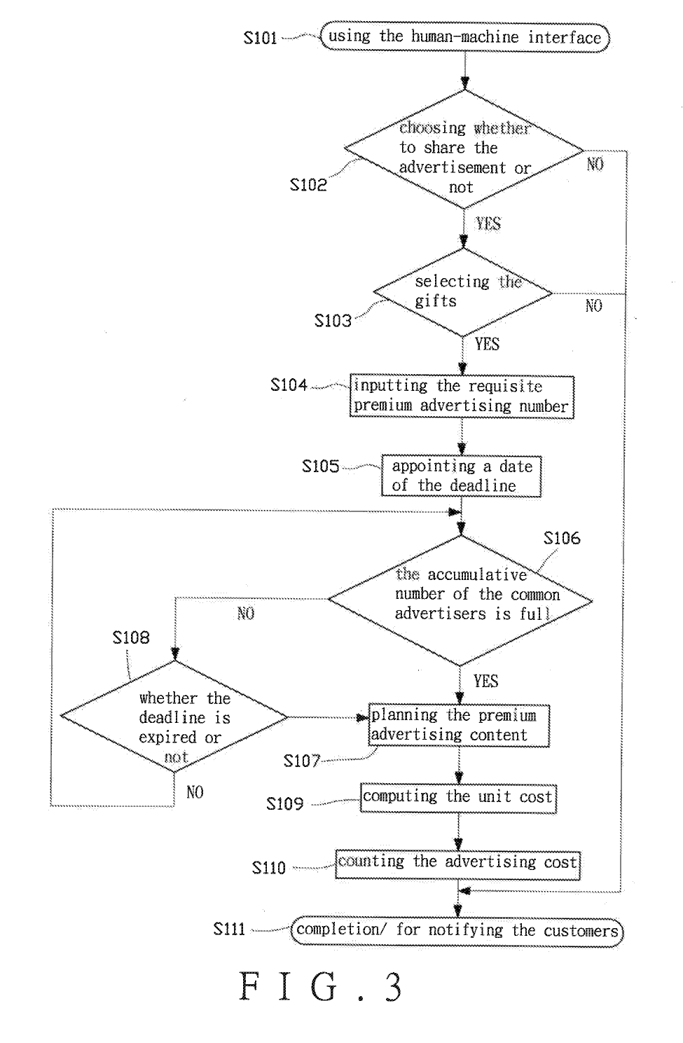

Referring to FIG. 3, the procedure includes:

S101: Using the human-machine interface.

S102: Choosing whether to share the advertisement.

S103: Selecting the gift of a sharing advertisement.

S104: Inputting the requisite premium advertising number.

S105: Appointing a deadline (i.e. a date).

S106: The accumulative number (of the common advertisers) is full(over/or equal to a predetermined value).

S107: Planning the advertising content.

S108: Whether the deadline is expired or not.

S109: Computing the unit cost.

S110: Counting the advertising cost (for each common advertiser).

S111: Completion/for notifying the cost.

Advertising Gift

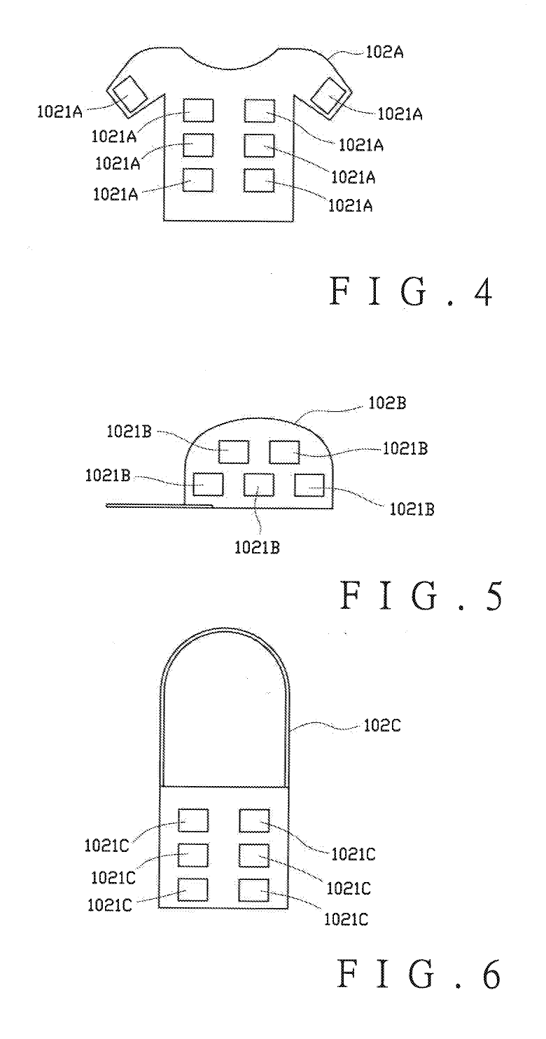

Referring to FIGS. 4 to 6, the preferred embodiments of the advertising gifts are shown. The advertising gifts 102A, 102B, and 102C are defined as T-shirts, hats, and handbags, which respectively include a plurality of advertisements 1021A, 1021B, and 1021C.

Preferred Embodiment of the Method in Operation

Referring to FIGS. 1 to 3, a user (U), who is normally an advertiser or an advertising supplier, operates the human-machine interface 10 in a computer 2, in a communication interface 3, or via a remote computer 4, receives an input information 101, and registers the input information in the customer database 11. The input information 101, which includes a deadline 103 and a premium advertising number 104, outputs an expiring signal 105 to the cost counter 13 via the deadline controller 12 while the deadline 103 is expired. The cost counter 13 counts a requisite advertising cost 106. The sharing counter 14 is applied to accumulate an accumulative number 107 of the advertisers who are going to share the advertisements for a same gift and at a same time. The sharing counter 14 outputs a full signal 108 to the cost counter 14 when the accumulative number 107 is over than or equal to a predetermined value so that the cost counter 14 counts an afforded advertising cost 106 of the advertisers. The cost counter 14 plans the advertising content of the gifts in accordance with the accumulative number 107 of the advertisers who are going to share advertisements, counts the unit cost 109 of each gift 102, and then counts the advertising cost 106 of each common advertiser in accordance with the premium advertising number 104 of each common advertiser.

The aforementioned method includes the following steps:

The user (U) uses the human-machine interface S101 and chooses whether to share the advertisement S102 on the human-machine interface 10 or not. If the selection of NO unwilling to share the advertisement is chosen, the user is willing to afford the premium advertising cost alone. Therefore, the step is directly turned to the completion S111 for notifying the cost. The selection of YES willing to share the advertisement is chosen, the user continues selecting the gift of the sharing advertisement S103, inputs the requisite premium advertising number S104, and appoints a deadline (i.e. a date) S105. After the accumulative number S106 of the common advertisers is full, the advertising content S107 is planned. However, even when the accumulative number of the advertisers is not full yet (i.e. not over/or equal to a predetermined value) and the step S106 is set by NO, the deadline is determined whether to be expired S108. If the determined result is NO, return to the step S106. If the result is YES, continue the step S107. Thereafter, the steps of computing the unit cost S109 and counting the advertising cost (for each common advertiser) S110 is progressed. Finally, the step of completion S111 for notifying the cost is progressed.

As a matter of fact, the mentioned steps are applied to operate the premium advertising cost-sharing matching method:

Operating a human-machine interface 10 in a computer 2, in a communication interface 3, or via a remote computer 4, comprising the following steps of:

Step A: applying a customer database 11 on the human-machine interface 10 to seek a sharing advertisement; if yes, following step B; if no, following step E;

Step B: applying a gift database 15 and the customer database 11 on the human-machine interface 10 to select a gift 102, input a demanded premium advertising number 104, and appoint a deadline 103;

Step C: applying a sharing counter 14 on the human-machine interface 10 to accumulate an accumulative number 107 of the common advertisers for a same gift and at a same time; if the accumulative number has reached a predetermined value, following step E, otherwise following step D;

Step D: applying a deadline controller 12 on the human-machine interface 10 to control whether the deadline 103 in the step B is expired or not; if yes, following step E; if no, following step C; and

Step E: applying a cost counter 13 on the human-machine interface 10 to count an advertising cost 106 afforded by each advertiser in accordance with the premium advertising number 104.

The mentioned steps are applied to execute the following method:

A premium advertising cost-sharing matching method of the present invention is applied to operate a human-machine interface 10 in a computer 2, in a communication interface 3, or via a remote computer 4. The human-machine interface 10 provides a gift 102 information in order to seek at least more than one common advertiser, then registers a premium advertising number 104 that the common advertiser needs, and appoints a deadline 103. An afforded advertising cost 106 is counted according to the premium advertising number 104 requisite for each common advertiser within or after the deadline 103.

The premium advertising cost-sharing matching method counts the advertising cost 106 after a number of the common advertisers reach a predetermined value.

The premium advertising cost-sharing matching method plans the advertising content of the gift before counting the advertising cost 106, then counts the unit cost 109 of each gift 102 in accordance with the accumulative number 107 of the common advertisers, and counts the advertising cost 106 in accordance with the premium advertising number 104 of each common advertiser.

With regard to the execution of the premium advertising cost-sharing matching gifts 102A, 102B, and 102C shown in FIGS. 4 to 6, the advertising gifts 102A, 102B, and 102C are defined as T-shirts, hats, and handbags, which respectively include at least more than two advertisements 1021A, 1021B, and 1021C, namely a plurality of advertisements.

Therefore, the present invention applies the aforementioned method and system to allow an advertising gift to be shared and posted by most of advertisers, which earns a same or even better advertising efficiency with the shared cost and greatly reduces the cost of single advertisements. Furthermore, due to the numerous sharing advertisements, the specialized impression could be weakened but still attain the effect of being visually read so as to reduce the waste problem that the consumer do not use gifts after taking them.

While we have shown and described the embodiment in accordance with the present invention, it should be clear to those skilled in the art that further embodiments may be made without departing from the scope of the present invention.

I claim:

1. A premium advertising cost-sharing matching method being applied to operate a human-machine interface in a computer, in a communication interface, or via a remote computer; said human-machine interface providing a gift information in order to seek at least more than one common advertiser, then registering a premium advertising number that said common advertiser needs, and appointing a deadline; said human-machine interface counting an afforded advertising cost according to said premium advertising number requisite for each common advertiser within or after said deadline.

2. The premium advertising cost-sharing matching method as claimed in claim 1, wherein said advertising cost is counted after a number of said common advertisers reaches a predetermined value.

3. The premium advertising cost-sharing matching method as claimed in claim 1, wherein an advertising content of said gift is planned before counting said advertising cost, then a unit cost of each gift is counted according to said accumulative number of said common advertiser, and said advertising cost of said common advertiser is counted according to said premium advertising number of each common advertiser.

4. A premium advertising cost-sharing matching system being operated in a computer, in a communication interface, or via a remote computer and providing a human-machine interface, a customer database, a deadline controller, and a cost counter; said human-machine interface receiving an input information of an advertiser and registering in said customer database; said input information including a deadline and a premium advertising number for outputting an expiring signal to said cost counter via said deadline controller when said deadline is expired, and then said cost counter counting a requisite advertising cost afforded by said advertiser.

5. The premium advertising cost-sharing matching system as claimed in claim 4, further comprising a sharing counter applied to accumulate an accumulative number of said advertisers who are going to share advertisements for a same gift and at a same time; said sharing counter outputs a full signal to said cost counter when said accumulative number is over than or equal to a predetermined value so that said cost counter counts an afforded advertising cost of said advertisers.

6. The premium advertising cost-sharing matching system as claimed in claim 4, wherein said cost counter plans an advertising content in accordance with an accumulative number of said advertisers who are going to share advertisements, counts a unit cost of each gift, and then counts said advertising cost of each common advertiser in accordance with said premium advertising number of each advertiser.

7. The premium advertising cost-sharing matching system as claimed in claim 4, further comprising a gift database; said gift database includes at least one representative figure of said gift; said representative figure includes a plurality of advertising areas separated by said gift.

8. The premium advertising cost-sharing matching system as claimed in claim 4, wherein said customer database includes at least one selected gift column, one advertising number column and one deadline column.

9. An advertising gift manufactured by said premium advertising cost-sharing matching as claimed in claims 1 including at least more than two advertisements.

10. An advertising gift manufactured by said premium advertising cost-sharing matching as claimed in claims 2 including at least more than two advertisements.

11. An advertising gift manufactured by said premium advertising cost-sharing matching as claimed in claims 3 including at least more than two advertisements 12. A premium advertising cost-sharing matching method being applied to operate a human-machine interface in a computer, in a communication interface, or via a remote computer and seek whether at least more than one advertiser is willing to share advertisement of a gift, comprising:
step A: applying a customer database on said human-machine interface to seek a sharing advertisement; if yes, following step B; if no, following step E;
step B: applying a gift database and said customer database on said human-machine interface to select a gift, input a requisite premium advertising number, and appoint a deadline;
step C: applying a sharing counter on said human-machine interface to accumulate an accumulative number of said common advertisers for a same gift and at a same time; if said accumulative number having reached a predetermined value, following step E, otherwise following step D;
step D: applying a deadline controller on said human-machine interface to control whether said deadline input in said step B is expired or riot; if yes, following step E; if no, following step C; and
step E: applying a cost counter on said human-machine interface to count an advertising cost afforded by each advertiser in accordance with said premium advertising number.
